(19) United States
(12) Patent Application Publication
(10) Pub. No.: US 2014/0041121 A1
(43) Pub. Date: Feb. 13, 2014

(54) Lumbar Folding Bed

(71) Applicant: JIAXING SHUFUDE ELECTRIC BED CO., LTD, ZHEJIANG (CN)

(72) Inventor: Huafeng Shan, Jiaxing City (CN)

(73) Assignee: JIAXING SHUFUDE ELECTRIC BED CO., LTD, ZHEJIANG (CN)

(21) Appl. No.: 13/958,846

(22) Filed: Aug. 5, 2013

Related U.S. Application Data
(63) Continuation-in-part of application No. 13/908,168, filed on Jun. 3, 2013.

(30) Foreign Application Priority Data
Aug. 7, 2012 (CN) 201220387006.5

(51) Int. Cl. A47C 21/00; A61G 7/015

(52) U.S. Cl. CPC A47C 21/006; A61G 7/015
USPC 5/618

(57) ABSTRACT

A lumbar folding bed includes a bed frame, and a board assembly that has a calf board, a thigh board pivotally mounted to the calf board, a seat board pivotally mounted to the thigh board, and a back board pivotally mounted to the seat board. A lumbar extension motor is connected to the board assembly. A lumbar extension rod is mechanically linked to the lumbar extension motor. The lumbar extension motor is configured to raise and lower the lumbar extension rod. A pair of calf board massagers are mounted to the calf board. The pair of calf board massagers includes a left calf board massager and a right calf board massager. The lumbar folding bed further optionally includes a pair of back board massagers.

This application is a continuation in part of U.S. patent application Ser. No. 13/908,168 filed Jun. 3, 2013, by the same inventor Huafeng Shan, the disclosure of which is incorporated herein by reference.

This application claims Paris Convention priority from China application entitled Electric Bed With Top Head And Waist Function, China application serial number 201220387006.5, to the same inventor Huafeng Shan filed Aug. 7, 2012, the disclosure of which is incorporated herein by reference.

### FIELD OF THE INVENTION

The utility model relates to electric bed, specifically the top of the head and waist with functional electric bed.

### DISCUSSION OF RELATED ARTS

Electric massage chairs and tables have gained popularity and are used by consumers around the world. However, over the years the structure and function of traditional electric bed has not changed much. The basic elements to a traditional adjustable electric bed are defined by four planks, where three of the four planks are moveable.

The typical electric motorized adjustable bed is exemplified by Eriksson in United States patent publication number US 2007/0163046 titled Articulated Bed, published Jul. 19, 2007, the disclosure of which is incorporated herein by reference. The Eriksson bed has three main components: an articulated mattress, a support frame for the mattress, and a power assembly for raising and lowering the flexible sections. The Eriksson mattress support is articulated through the division of four areas, held together by a hinge mechanism.

Over variations of the electric motorized adjustable bed are discussed in Hensley United States patent publication number US 2001/0000828, published May 10, 2001, titled Articulating Bed Frame which describes an articulating bed frame including a base, a frame supported by the base, a deck supported by the frame, and a unit received by the opening, the disclosure of which is incorporated herein by reference. The aforementioned unit is the electrical control box. Henley's bed assembly also operates as a massager, which was not a component of Eriksson et al's patent.

Hospital patients have been users of articulated adjustable beds. Many patients are unable to leave the room for extended periods of time due to surgery or other complications; therefore, they depend on these beds significantly for comfort. Taguchi in United States patent publication number US 2005/0076440 titled Adjustable Bed, published Apr. 14, 2005, the disclosure of which is incorporated herein by reference, states that the problem with some adjustable beds is during the rising of the bed a user is sometimes forced downward and some of these users are independently unable to readjust themselves. Taguchi's invention proposes a mechanism that takes into account the motion center of a user's body.

It is an object of the invention to improve upon the traditional adjustable electric bed by adding additional functionality and comfort, especially for those patients that watch television for extended amounts of time.

### SUMMARY OF THE INVENTION

A lumbar folding bed includes a bed frame, a board assembly that has a calf board, a thigh board pivotally mounted to the calf board, a seat board pivotally mounted to the thigh board, and a back board pivotally mounted to the seat board. A lumbar extension motor is connected to the board assembly. A lumbar extension rod is mechanically linked to the lumbar extension motor. The lumbar extension motor is configured to raise and lower the lumbar extension rod.

A pair of calf board massagers is mounted to the calf board. The pair of calf board massagers includes a left calf board massager and a right calf board massager. The lumbar folding bed further optionally includes a pair of back board massagers. The pair of back board massagers may have a left back board massager and a right back board massager. Additionally, a head board can be pivotally mounted to the back board. A head board motor can be connected between the head board and the backboard.

Preferably, the headboard width is less than the backboard width. Preferably, a headboard width is less than a seat board width. Also, a headboard width should be is less than a thigh board width. A headboard width can be less than a calf board width. The head board motor can be a headboard linear motor that extends from a retracted position to a headboard linear motor extended position. Actuation and extension of the headboard linear motor raises the headboard. The lumbar extension rod is configured to be raised to a lumbar height of at least 10 cm.

A pivoting lumbar axle bar can be connected to the lumbar extension motor. The pivoting lumbar axle bar may also have a pair of lumbar arms mounted to pass through a pair of lumbar openings. The pair of lumbar openings are formed on the backboard. The lumbar extension motor is configured to rotate the pivoting lumbar axle bar. The pivoting lumbar axle bar is rigidly connected to a lumbar extension rod at the pair of lumbar arms. The lumbar extension rod is mounted above the back board. The pivoting lumbar axle bar is mounted below the backboard.

### BRIEF DESCRIPTION OF THE DRAWINGS

FIG. 1 shows the bottom perspective view of the electric bed including the pivoting lumbar axle bar connected to the lumbar extension motor and having pair of lumbar arms mounted to pass through a pair of lumbar openings.

FIG. 2 shows the top plan view of the electric bed including the lumbar extension rod.

FIG. 3 is a bottom view of the present invention.

FIG. 4 is a side view diagram of the present invention showing the folding of the lumbar folding bed in a fully extended position including some sample angular positions.

FIG. 5 is a side view diagram showing additional sample angular positions.

The following call out list of elements can be a useful guide in referencing the element numbers of the drawings.

1 Metal Bed Frame

2 Calf Board

3 Thigh Board

4 Seat Board

5 Back Board

6 Head Board

7 Head Board Motor

8 Lumbar Extension Motor

9 Lumbar Extension Rod

21 Right Lumbar Arm

22 Left Lumbar Arm

23 Right Lumbar Opening

24 Left Lumbar Opening

25 Pivoting Lumbar Axle Bar

### DETAILED DESCRIPTION OF THE PREFERRED EMBODIMENT

The following detailed description accompanies the drawings described above. The drawings and description are for reference and do not limit the scope of the claims. As persons of ordinary skill in the art are familiar with the traditional four plank board assembly, less details regarding the traditional four plank board assembly are discussed. A traditional folding bed having a traditional four plank board assembly can be modified by adding the additional elements of the present invention.

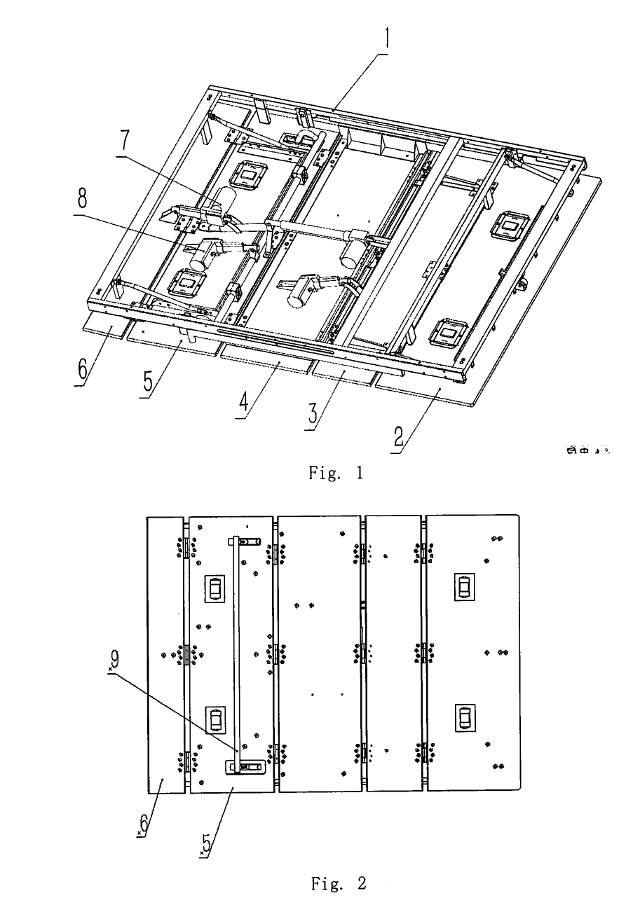

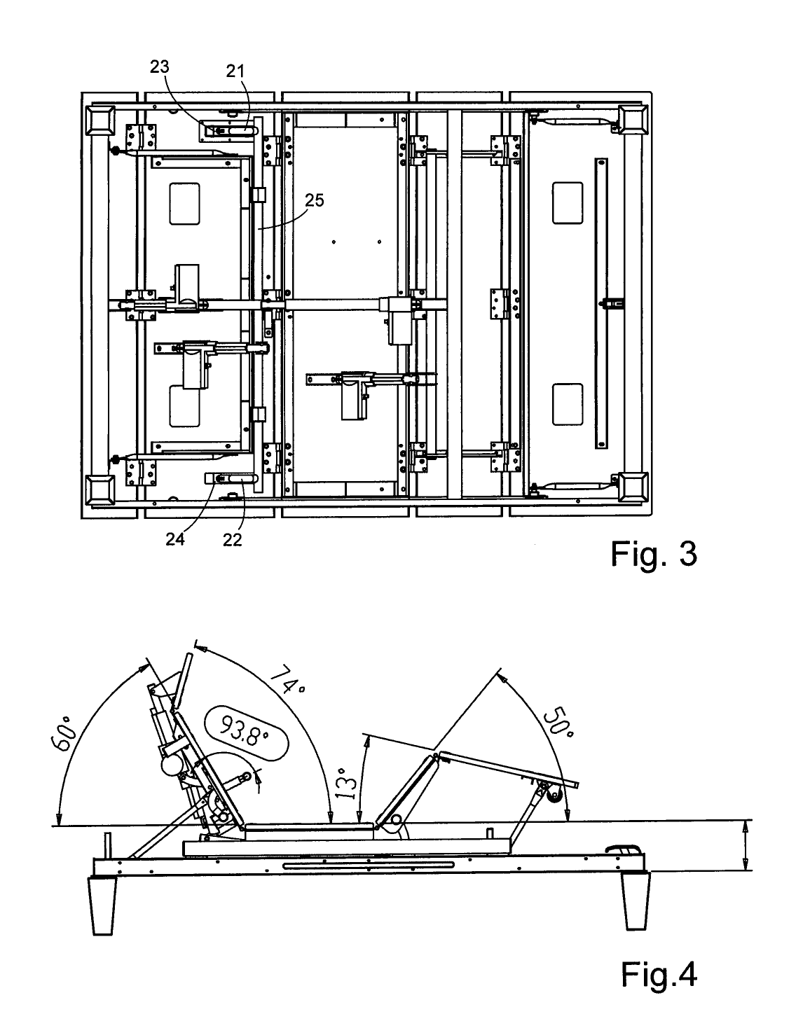

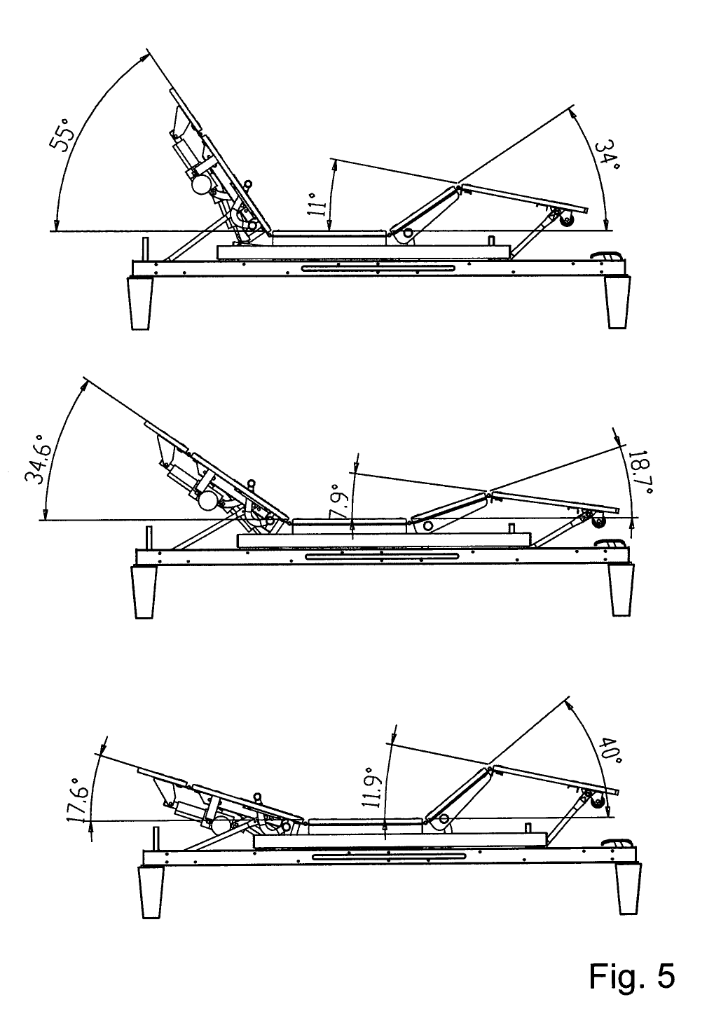

Generally, as seen in FIG. 1 and FIG. 2 the folding bed has a head board and a lumbar extension feature that is motorized on an electric bed. The folding bed is supported by legs that are mounted to and support a metal bed frame 1. The metal bed frame 1 supports and articulates a board assembly. The board assembly in turn supports and articulates a bed mattress that can be made of memory foam. The board assembly can be made of plywood sheets.

The board assembly supports the mattress and because the mattress is attached to the board assembly, the mattress moves with the board assembly when the board assembly is moved. The board assembly has a sequential hinging of a calf board 2 hinged to a thigh board 3, which is hinged to a seat board 4, which is hinged to a back board 5, which is hinged to a head board 6. The mattress accordingly has the same sections, namely the calf section, the thigh section, the seat section, the back section and the head section.

Each of the sections are articulated by motorized servo such as linear motors. The head board six can be moved independently of other board assembly sections. The board assembly beneath the headboard is preferably supported by a metal bed frame that can lift the headboard using the headboard motor 7.

The headboard 6 is pivotally mounted to the backboard 5. The headboard 6 has a width that is preferably less than the backboard 5. The backboard 5 preferably has a headboard motor 7 that is mounted between the backboard and the headboard 6. The head board motor 7 as a telescopic extending rod that is affixed to a headboard bracket. The headboard bracket has a pivotal connection to the telescopic extending rod. The headboard bracket can be screwed down to the headboard 6 with wood screws. The headboard motor 7 may be pivotally connected to a backboard bracket. The backboard bracket is screwed or otherwise connected to the backboard. As the linear motor headboard motor increases in length, the headboard six pushes up against the mattress which pushes up a head portion of the mattress which in turn changes the head position of the user.

The lumbar extension motor 8 can be formed as a linear motor that rotates a pivoting lumbar axle bar 25 that is located underneath the board assembly and mounted underneath the board assembly such as by screw attachment to a lower surface of the board assembly. The pivoting lumbar axle bar is preferably mounted on a pair of pivots. The pair of pivots are preferably mounted to an underside of the back board 5. The pivoting lumbar axle bar is preferably welded to a pair of lumbar arms. The pair of lumbar arms are mounted to pass through lumbar openings. The pair of lumbar openings can be cut through the plank of wood forming the backboard 5. Each lumbar opening, namely the left lumbar opening 24 and the right lumbar opening 23 can receive a rectangular plastic grommet to maintain soft or smooth edges of the particular lumbar opening. The pair of lumbar arms include a left lumbar arm 22 and a right lumbar arm 21.

The lumbar arms are connected to the lumbar extension rod. The lumbar extension rod 9 is mounted parallel to the pivoting lumbar axle bar. The lumbar extension rod is mounted to the left lumbar arm at a lumbar extension rod left end and the lumbar extension rod is mounted to the right lumbar arm at a lumbar extension rod right end. The lumbar extension rod is rigidly connected to the left lumbar arm. The lumbar extension rod is rigidly connected to the right lumbar arm. The left lumbar arm and the right lumbar arm are rigidly connected to the pivoting lumbar axle bar. The lumbar extension rod, the right lumbar arm, the left lumbar arm and the pivoting lumbar axle bar are all rigidly connected to each other to form a lumbar frame. The lumbar extension rod 9 can be received in a lumbar extension rod slot formed on an upper surface of the backboard 5 so that the lumbar extension rod 9 rotates to a flush configuration. Optionally, the lumbar extension rod 9 can rest on a flat surface of the upper surface of the backboard 5 with no lumbar extension rod slot formed so that the lumbar extension rod 9 does not rotate to a flush configuration.

When the lumbar extension motor 8 is formed as a linear motor and extends and contracts. When the lumbar extension motor 8 contracts, it is configured to rotate the pivoting lumbar axle bar, which in turn rotates the pair of lumbar arms, which in turn rotates the lumbar extension rod 9 about the axis defined by the axis of rotation of the pivoting lumbar axle bar. The actuation of the lumbar extension motor 8 in extension lowers the lumbar extension rod 9 to a lowered stowed position, and the actuation of the lumbar extension motor 8 in retraction, raises the lumbar extension rod 9 to a raised deployed position.

The head position and lumbar position are both independent of each other because they have separate independent motor control. The lumbar extension rod 9 is preferably configured to be raised to a lumbar height of over 10 cm so that even with a thick mattress, the lumbar extension rod can assist user posture. The lumbar extension rod is preferably of the circular cross-section and wrapped in a cloth cover sleeve so that it does not scratch the mattress easily.

The present invention described above is only a preferred embodiment, unintended to limit the scope of the invention. Obvious and equivalent modifications derived from the essence of this invention should belong within its scope. For example, the present invention can include vibrating massage members. The lumbar folding bed can also have vibrating massage members attached to an underside of the board assembly. As seen in the figures, rectangular openings receive rectangular massage drive motors. The massage drive motors can be loaded with an eccentric mass for a vibration massage. The massage drive motors can be mounted on the rectangular openings easily if the massage drive motors have rectangular motor mounts. A pair of massage elements can be seen on the calf board 2 and also on the back board 5.

The scope of this invention is defined by the following claims.

1. A lumbar folding bed comprising:
a. a bed frame;
b. a board assembly including: a calf board; a thigh board pivotally mounted to the calf board; a seat board pivotally mounted to the thigh board; a back board pivotally mounted to the seat board;
c. a lumbar extension motor connected to the board assembly;
d. a lumbar extension rod mechanically linked to the lumbar extension motor, wherein the lumbar extension motor is configured to raise and lower the lumbar extension rod.

2. The lumbar folding bed of claim 1, further comprising: a pair of calf board massagers mounted to the calf board, wherein the pair of calf board massagers includes a left calf board massager and a right calf board massager.

3. The lumbar folding bed of claim 1, further comprising: a pair of back board massagers, wherein the pair of back board massagers includes a left back board massager and a right back board massager.

4. The lumbar folding bed of claim 1, further comprising: a pair of calf board massagers mounted to the calf board, wherein the pair of calf board massagers includes a left calf board massager and a right calf board massager; and a pair of back board massagers, wherein the pair of back board massagers includes a left back board massager and a right back board massager.

5. The lumbar folding bed of claim 1, further comprising:
a. a head board pivotally mounted to the back board;
b. a head board motor connected between the head board and the backboard.

6. The lumbar folding bed of claim 5, wherein a headboard width is less than a backboard width.

7. The lumbar folding bed of claim 5, wherein a headboard width is less than a seat board width.

8. The lumbar folding bed of claim 5, wherein a headboard width is less than a thigh board width.

9. The lumbar folding bed of claim 5, wherein a headboard width is less than a calf board width.

10. The lumbar folding bed of claim 5, wherein the head board motor is a headboard linear motor that extends from a retracted position to a headboard linear motor extended position, wherein actuation and extension of the headboard linear motor raises the headboard.

11. The lumbar folding bed of claim 5, wherein the lumbar extension rod is configured to be raised to a lumbar height of at least 10 cm.

12. The lumbar folding bed of claim 1, further comprising: a pivoting lumbar axle bar connected to the lumbar extension motor, wherein the pivoting lumbar axle bar further includes a pair of lumbar arms mounted to pass through a pair of lumbar openings, wherein the pair of lumbar openings are formed on the backboard, wherein the lumbar extension motor is configured to rotate the pivoting lumbar axle bar, wherein the pivoting lumbar axle bar is rigidly connected to a lumbar extension rod at the pair of lumbar arms, wherein the lumbar extension rod is mounted above the back board, wherein the pivoting at lumbar axle bar is mounted below the backboard.

13. The lumbar folding bed of claim 12, further comprising:
a. a head board pivotally mounted to the back board;
b. a head board motor connected between the head board and the backboard.

14. The lumbar folding bed of claim 13, wherein a headboard width is less than a backboard width.

15. The lumbar folding bed of claim 13, wherein a headboard width is less than a seat board width.

16. The lumbar folding bed of claim 13, wherein a headboard width is less than a thigh board width.

17. The lumbar folding bed of claim 13, wherein a headboard width is less than a calf board width.

18. The lumbar folding bed of claim 13, wherein the head board motor is a headboard linear motor that extends from a retracted position to a headboard linear motor extended position, wherein actuation and extension of the headboard linear motor raises the headboard.

19. The lumbar folding bed of claim 13, wherein the lumbar extension rod is configured to be raised to a lumbar height of at least 10 cm.
